(19) United States
(12) Patent Application Publication
(10) Pub. No.: US 2008/0082386 A1
(43) Pub. Date: Apr. 3, 2008

(54) Systems and methods for customer segmentation

(75) Inventors: Stuart Alan Cunningham, Hanna City, IL (US); William Thomas Franey, Washburn, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/529,484

(22) Filed: Sep. 29, 2006

(51) Int. Cl. G06F 9/46

(52) U.S. Cl. 705/8

(57) ABSTRACT

Systems and methods are disclosed for managing customers using customer segmentation. In one embodiment, a customer relationship manager may implement a customer management architecture to define one or more customer segmentation rules based on one or more business metrics, and to organize customers into one or more customer groups based on the one or more customer segmentation rules. The customer relationship manager may then establish a customer segment based on the one or more customer groups, and develop a segment management plan for managing customers in the customer segment. Using the customer management architecture, the customer relationship manager may further set a growth target for the customer segment, and track performance of the customer segment in achieving the growth target.

### TECHNICAL FIELD

The present disclosure generally relates to methods and systems for managing customers, and more particularly, to methods and systems for managing customers through customer segmentation.

### BACKGROUND

Customer segmentation refers to the subdivision of a market into discrete customer groups that share similar characteristics. For example, a machine manufacturer may manage customers by grouping them according to a single dimension, such as the type of machine purchased from the manufacturer (e.g., paving equipment, underground mining equipment, etc.). However, to better monitor the performance of sales revenue growth, sales organizations may desire to group customers by more than one dimension, so as to organize marketing and sales efforts around selected groups of customers.

Systems and methodologies have been developed to manage marketing and sales efforts based on customer characteristics. One approach to customer management is to generate a strategic marketing plan for growing and retaining customers in an industry. For example, U.S. Patent Application No. 2004/0122725 by Womack et al. discloses a method for managing customers by conducting behavior examination for one or more customers based on a recency factor, a frequency factor, and a monetary factor. The method includes assigning the one or more customers into a segment set based on a score. The score includes a value associated with the recency factor, the frequency factor, and the monetary factor. The method further includes assessing a customer need through a qualitative assessment and a quantitative assessment, and generating a strategic marketing plan based on the customer segmentation and the assessment.

While conventional systems and methods may provide some mechanism for managing customers, they are often limited by specific rules used to organize the customers. Further, conventional systems focus on managing customers based on a fixed set of customer characteristics, and therefore do not provide a solution that allows flexible customer segmentation.

Therefore, there is a need to provide a process with flexibility in defining customer segmentation rules and determining customer segments. The disclosed embodiments improve upon prior art systems by providing a rules based customer segmentation approach that enables an entity to develop customized marketing plans based on customer segmentation and to track the performance of each customer segment.

### SUMMARY OF THE INVENTION

Systems and methods are disclosed for managing customers using customer segmentation. In one embodiment, a customer relationship manager may implement a customer management architecture to define one or more customer segmentation rules based on one or more business metrics, and to organize customers into one or more customer groups based on the one or more customer segmentation rules. The customer relationship manager may then establish a customer segment based on the one or more customer groups, and develop a segment management plan for managing customers in the customer segment. Using the customer management architecture, the customer relationship manager may further set a growth target for the customer segment, and track performance of the customer segment in achieving the growth target.

### BRIEF DESCRIPTION OF THE DRAWINGS

The accompanying drawings, which are incorporated in and constitute a part of this specification, illustrate exemplary embodiments and together with the description, serve to explain these disclosed embodiments. In the drawings:

FIG. 1 is a block diagram of an exemplary customer management architecture consistent with certain embodiments of the present disclosure;

FIG. 2 is a flow chart of an exemplary customer management process consistent with certain embodiments of the present disclosure;

FIG. 3A is an exemplary set of customer segmentation rules consistent with certain embodiments of the present disclosure;

FIG. 3B is an exemplary set of customer segments consistent with certain embodiments of the present disclosure;

FIG. 3C is an exemplary set of sales growth targets based on customer segmentation consistent with certain embodiments of the present disclosure; and

FIG. 3D is an exemplary graph of sales growth performance of three customer segments consistent with certain embodiments of the present disclosure.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

In this disclosure, a customer may be an individual or an organization having business dealings with another business enterprise. A sales organization may be a sales department within a business enterprise, such as a dealership, or a network of dealerships. A sales organization may also be a business entity dedicated to selling products and/or services. Customer management refers to business activities related to managing data and business dealings of one or more customers.

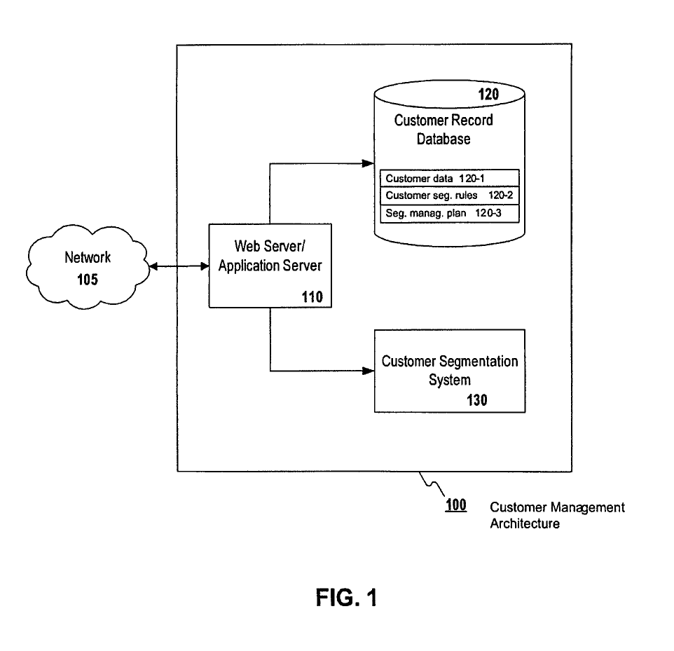

FIG. 1 is a block diagram illustrating an exemplary customer management architecture 100 consistent with certain disclosed embodiments. Customer management architecture 100 may be a computer system including, for example, a Web server/application server module 110, a customer record database 120, and a customer segmentation system 130. Web server/application server module 110 interfaces with network 105 and is also connected to customer record database 120 and customer segmentation system 130. It is contemplated that a customer management architecture 100 may include some, all, or additional components than those illustrated in FIG. 1.

Network 105 may be any type of wireline or wireless communication network for exchanging or delivering information or signals, such as the Internet, a wireless local area network (LAN), or any other network. Thus, network 105 may be any type of communications system. For example, users and systems of customer management architecture 100 may send or receive data using network 105.

Web server/application server module 110 may be a computer system configured to perform certain processes consistent with the disclosed embodiments. Web server/application server module 110 may include any type of web server and/or application server software, such as the Apache HTTP Server from the Apache Software Foundation. Web server/application server module 110 may include an interface device (e.g., graphical user interface) for a customer relationship manager to access customer record database 120 and/or customer segmentation system 130. A customer relationship manager may be a person who works for a sales organization and is responsible for managing the sales organization's customer data records and customer relationships. A customer relationship manager may manage a customer account by accessing and analyzing customer and sales data from customer record database 120.

Web server/application server module 110 may include additional software/hardware components, such as collaboration tools (e.g., Microsoft Exchange Server 2003) that permit users (e.g., customer relationship managers) to share data, bulletin boards that permit customer relationship managers to communicate with each other, and/or search engines to provide efficient access to specific entries in customer record database 120 and/or customer segmentation system 130. Web server/application server module 110 may also implement software that allows customer relationship managers to submit records to be added to customer record database 120. Thus, web server/application server module 110 may include one or more software and/or hardware components that enable a user or software process to manage information contained in customer management architecture 100.

Customer record database 120 may be a system including hardware and/or software executed by a processor that is configured to store customer data and sales data records, charts, entries for changes made to the records, and other information used by one or more components of customer management architecture 100. For example, customer record database 120 may include one or more memory devices and/or memory controllers. Customer management architecture 100 may include one or more sales record databases 120.

In one embodiment, dealership A may implement a customer management architecture 100 including a customer record databases 120. For example, as shown in FIG. 1, customer record database 120 may include customer data record 120-1 that may include data reflecting a customer's nature of business and business dealings with dealership A. Customer record database 120 may also include customer segmentation rules 120-2. A customer segmentation rule 120-2 may be any type of business metric or management goal that is used to manage customers by organizing customers into customer segments. For example, a customer relationship manager may define last year's sales revenue as a customer segmentation rule 120-2. The customer relationship manager may also use customer management architecture 100 to group customers based on the customer segmentation rule 120-2, i.e., according to customers' sales revenue with dealership A last year. Further, a customer relationship manager may use customer management architecture 100 to implement one or more customer segmentation rules 120-2 to organize customers into one or more customer segments.

Customer record database 120 may also include customer segment management plans 120-3. A customer segment management plan 120-3 may be used by a customer relationship manager to manage one or more customer segments. For example, a customer segment management plan 120-3 may include marketing and sales plans with marketing and sales related action items for a sales organization (e.g., dealership A). A customer segmentation management plan 120-3 may include sales growth targets (e.g., increased sales revenue, etc.) for one or more customer segments. A customer segment management plan 120-3 may also include one or more action plans for managing timelines, tasks, and deliverables related to the action items and sales growth targets. A customer segment management plan 120-3 may further include executable program codes that provide reports and graphics showing the progress of one or more action items and the progress in achieving sales growth targets. A customer segment management plan 120-3 may also include a customer relationship development plan that may be implemented to strengthen and expand customer relations with one or more customers in a customer segment.

Customer segmentation system 130 may be a computer system or software stored on one or more memory devices and executed by a processor that is configured to provide access to data stored in customer record database 120. Customer segmentation system 130 may receive one or more requests through web server/application server 110. Based on the request, customer segmentation system 130 may define, create, access, update, and/or delete data records stored in customer record database 120 to perform customer management functions.

Customer segmentation system 130 may include an expert system. The expert system may be a software program executed to analyze data (e.g., customer data records 120-1) using a set of rules (e.g., customer segmentation rules 120-2). Customer segmentation system 130 may include software programs implementing one or more customer management methods, such as customer segmentation. Based on customer data analysis, customer segment system 130 may implement processes according to the customer segmentation method, and recommend user actions.

In one embodiment, a customer relationship manager may use customer segmentation system 130 to define or customize templates for customer data record 120-1, customer segmentation rules 120-2, and a customer segment management plan 120-3, and/or to update customer data 120-1, customer segmentation rules 120-2, and a customer segment management plan 120-3. Customer segmentation system 130 may provide a requested customer data record 120-1, customer segmentation rule 120-2, and a customer segment management plan 120-3 to another component of customer management architecture 100 through web server/application server module 110. Alternatively, customer segment system 130 may also provide customer data 120-1, customer segmentation rules 120-2, and a customer segment management plan 120-3 directly to other components of customer management architecture 100.

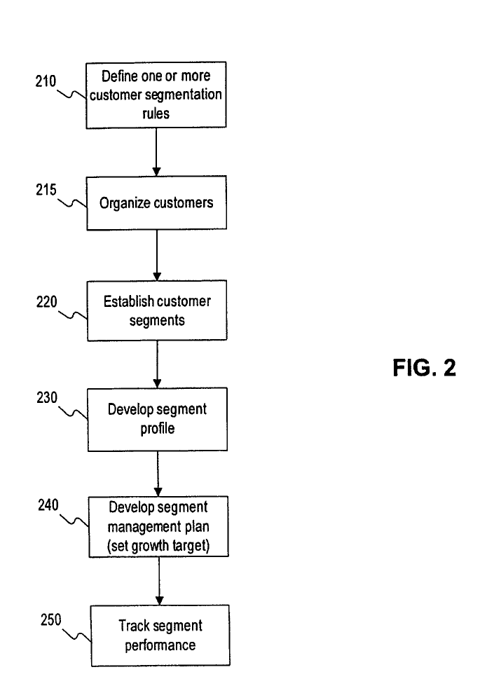

FIG. 2 is a flow chart of an exemplary process for managing customers based on customer segmentation consistent with certain disclosed embodiments. In one embodiment, a user (e.g., a customer relationship manager) may use customer segmentation system 130 to define one or more customer segmentation rules 120-2 (Step 210). A customer relationship manager may define a customer segmentation rule 120-2 by implementing customer management architecture 100 to collect and analyze customer data records 120-1 with information such as past sales revenues, projected/planned purchases, industry codes, service preference, and/or business locations. A customer relationship manager may also implement customer segmentation system 130 to organize customers according to the defined customer segmentation rules 120-2 (Step 215).

In one embodiment, a customer relationship manager may define a customer segmentation rule 120-2 based on industry codes. The customer relationship manager may then organize customers according to the customer segmentation rule 120-2 (e.g., grouping customers by industry codes). An industry code may refer to a classification system that categorizes products/services provided by a business. An industry code may be defined by a government entity or a private entity. Examples of such classification systems are North American Industry Classification System (NAICS) and the U.S. Standard Industrial Classification (SIC) system, etc.

For example, one industry code may be “general construction.” The customer relationship manager may define a customer segmentation rule 120-2 with industry code equal to “general construction.” The customer relationship manager may then organize all customers with industry code of “general construction” into one customer group.

In another embodiment, a customer relationship manager may define a customer segmentation rule 120-2 based on service preferences. The customer relationship manager may then organize customers according to their service preferences. Service preference may refer to a customer's past purchasing patterns in parts and services. For example, a sales organization may determine a customer's service preference based on the customer's purchases in machine parts and services in the past twelve months. The sales organization may define a customer whose service purchases amount to less than 30% of its machine part purchases as a “do it myself” (DIM) customer. The customer relationship manager may then organize all DIM customers into a customer group based on their service preferences. Because a DIM customer has relatively small amount of service purchases (i.e., less than 30% of machine part purchases), the sales organization may decide that the DIM customer group may be a good candidate to cross-sell more services.

Other service preference categories may also be defined. For example, a sales organization may define a customer whose service purchases amount to 30%-70% of its machine part purchases as a “work with me” (WWM) customer; and a customer whose service purchases amount to more than 70% of its machine part purchases as a “do it for me” (DFM) customer. In certain examples, and based on past sales and profitability, a sales organization may consider some of the DFM customers to be the most profitable and loyal to the sales organization.

To better explain these aspects of the disclosed embodiments, consider an example where customer relationship manager A works for a dealership, such as dealership A. Dealership A may offer various products and services to its customers. Customer relationship manager A may select certain customer groups on which to focus dealership A's marketing efforts by implementing customer management architecture 100 to organize the customers of dealership A. For example, customer relationship manager A may choose to focus on general construction (i.e., industry code) customers with certain ratios of past service/machine part purchases (i.e., service preference). As such, customer relationship manager A may define a customer segmentation rule 120-2 using industry code (i.e., industry code=general construction) and customer service preference (i.e., service preference=DIM, or WWM, or DFM). For example, one of the customer segmentation rules 120-2 may define the subset of all customers with industry code of “general construction” and service preference of “DIM.”

Further, customer relationship manager A may define one or more additional customer segmentation rules 120-2 based on dealership A's management goals. For example, one such management goal may indicate that for customers with a projected annual part purchases of less than $20,000, dealership A may manage their requests and services through a call center. Dealership A may estimate the projected annual purchases based on customer data 120-1. For example, based on a customer's current ownership of machines (i.e., customer data 120-1), dealership A may use customer segmentation system 130 (e.g., the expert system) to estimate the customer's purchases for replacement parts and machines (e.g., based on machine life cycles) in future months.

Customer relationship manager A may used one or more customer segmentation rules 120-2 to organize customers. In the above example, when organizing customers, customer relationship manager A may use customer segmentation system 130 to apply two customer segmentations rules 120-2. That is, customer relationship manager A may first group customers by industry codes and service preferences, and then further group customers by dealership management goals.

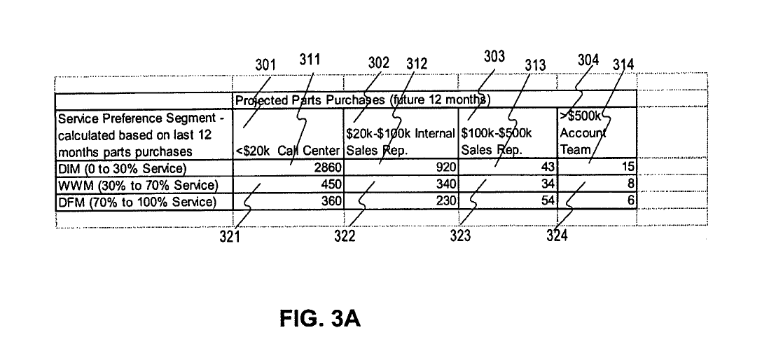

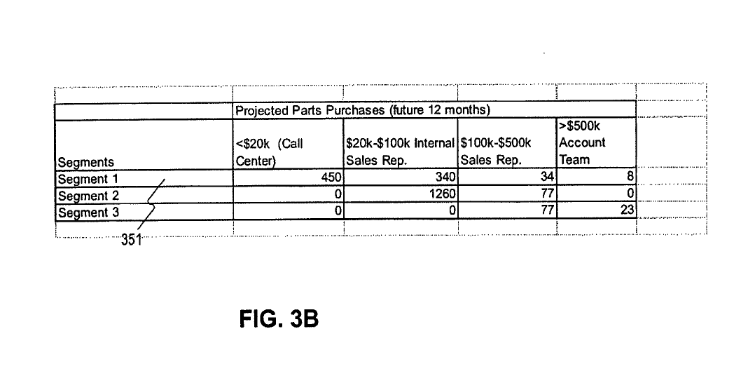

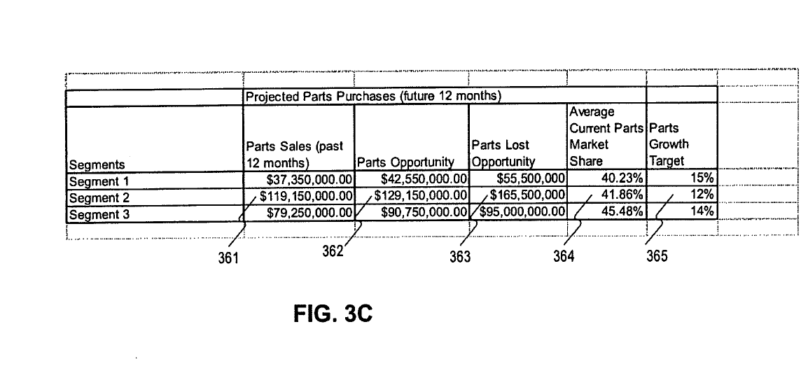

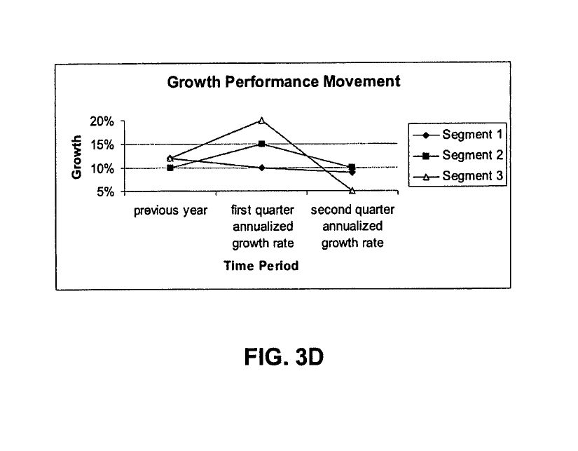

FIG. 3A shows an exemplary table of customers organized according to the above exemplary customer segmentation rules 120-2. Using customer segmentation system 130, customer relationship manager A may analyze customer data records 120-1 and group customers first according to the customer segmentation rule 120-2 based on industry codes and service preferences. Customer relationship manager A may further use customer segmentation system 130 to group customers according to the customer segmentation rule 120-2 based on dealership management goals.

In FIG. 3A, after grouping customers according to the two customer segmentation rules 120-2 described above, it is shown that dealership A has 2,860 general construction (industry code), DIM (service preference) customers (customer group 311) with projected annual part purchases of less than $20,000. As shown in FIG. 3A, dealership A may address inquires and requests from this group of customers through a call center (management goal—301). For customers with projected annual part purchases of $20,000-$100,000, dealership A may use internal sales representatives to manage the related business activities (management goal—302). An internal sales representative may refer to a member of dealership A staff who provides customer service remotely from dealership A (i.e., does not visit customer sites, such as customer headquarters, offices, etc.). As shown in FIG. 3A, dealership A may have 920 general construction DIM customers (customer group 312) with projected annual part purchases of $20,000-$100,000. Alternatively, for customers with projected annual part purchases of $100,000-$500,000, dealership A may manage the related business activities through customer sales representatives who visit customer sites regularly (management goal—303). Dealership A may have 43 general construction, DIM customers (customer group 313) with projected annual part purchases of $100,000-$500,000. Dealership A may use customer account teams to manage related activities for customers with projected annual part purchases of more than $500,000 (management goal—304). Dealership A may have 15 general construction, DIM customers (customer group 314) with projected annual part purchases of over $500,000. A customer account team may consist of one or more team members who closely monitor and manage one or more customers. A team member may be a marketing, sales, or service staff member who is responsible for providing information and services to a customer, or managing the relationship with a customer. A customer account team may include team members who serve various customer management functions (e.g., marketing, sales, and/or customer support, etc.).

Returning to FIG. 2, after defining customer segmentation rules and organizing customers accordingly, a customer relationship manager may establish one or more customer segments (Step 220). To do so, in one embodiment, a customer relationship manager may select one or more groups of customers organized according to customer segmentation rules 120-2 to form a customer segment. A customer relationship manager may focus further analysis and customer management efforts on one or more customer segments.

In the example shown in FIG. 3A, the DIM and WWM customers have relative moderate level of service purchases (i.e., less than 30% or 30%-70% of their machine part purchases) in comparison to the DFM customers (i.e., over 70% of machine part purchases). To increase sales revenue for services, customer relationship manager A may focus marketing efforts on WWM customers. Customer relationship manager A may therefore select customer groups 321, 322, 323, and 324 as customer segment 1. Customer relationship manager A may also analyze mid-tier customers, and therefore select customer groups 312, 313, 322 and 323 as customer segment 2. Customer relationship manager A may further focus on customers with relatively large sales revenues in parts, but with relatively moderate sales revenues in services. Accordingly, customer relationship manager A may select customer groups 313, 314, 323, and 324 as customer segment 3.

To illustrate customer segments, FIG. 3B shows the above exemplary customer segmentation with projected part purchases for the next twelve months. As discussed earlier, customer segmentation system 130 may estimate future parts sales based on customers' current machine ownership and data related to machine life cycles. As shown in FIG. 3B, among the customers in customer segment 1 (351), 450 customers have projected part purchases of less than $20,000 (customer management activities managed by a call center); 340 customers have projected part purchases of $20,000-$100,000 (customer management activities managed by internal sales representatives); 34 customers have projected part purchases of $100,000-$500,000 (customer management activities managed by customer sales representatives); and 8 customers have projected part purchases of over $500,000 (customer management activities managed by account teams). FIG. 3B also shows customer segment 2 (FIG. 3A, groups 312, 313, 322, and 323) and segment 3 (FIG. 3A, groups 313, 314, 323, and 324) with projected part purchases for the next twelve months.

After establishing customer segments, the customer relationship manager may use customer segmentation system 130 to develop a customer segment profile for each customer segment (Step 230). The customer relationship manager may use customer management architecture 100 to gather and analyze customer data records 120-1 for each customer segment.

For example, as shown in FIG. 3B, customer relationship manager A may focus on customer segment 2 to create a customer segment profile for this segment. To do so, customer relationship manager A may use customer segmentation system 130 to retrieve customer data records 120-1 from customer record database. Customer data records 120-1 may include customer information such as information reflecting the nature of a customer's business, market information, etc. For example, the customer data records 120-1 for customers in customer segment 2 (FIG. 3A, groups 312, 313, 322, and 323) may indicate that this customer segment contains a large percentage of medium sized companies that perform routine machine maintenance tasks by themselves. Further, customer data records 120-1 may indicate that a large percentage of customers in segment 2 have workshops and a staff of technicians to perform machine services. Customer relationship manager A may then create a customer segment profile based on information reflecting these characteristics of customers in segment 2.

Customer segmentation system 130 may include software that allows customer relationship manager A to analyze lost sales opportunities when creating a customer segment profile. For example, customer relationship manager A may implement customer management architecture 100 to estimate the total parts sales opportunities for the past year in a customer segment based on information reflecting the corresponding customers' machine ownership and construction work load. Lost sales opportunities may be defined as the difference between the total sales opportunities and the actual sales revenue for that customer segment. Customer relationship manager A may include the lost sales opportunities for a customer segment in the customer segment profile, indicating whether the customer segment has large or small amount of potential revenue in lost sales opportunities. Customer segmentation system 130 may determine lost sales opportunities based on different types of information, such as marketing studies, statistics of sales of competing brands, etc.

FIG. 3C shows a table with exemplary lost sales opportunities for each of the above described customer segments. For example, as shown in FIG. 3C, dealership A sold $119,150,000 (361) in machine parts to customer segment 2 in the past twelve months. Based on sales statistics of other dealers or market research data, customer segmentation system 130 may determine that dealership A has lost sales opportunities amounting to $165,500,000 (363) in the past twelve months. That is, in the market for certain machine parts, dealership A sold 41.86% (364) of all parts sold to customers in segment 2. Customer relationship manager A may include the lost sales opportunities for customer segments 1, 2, and 3, as shown in FIG. 3C, in the corresponding customer segment profiles.

After analyzing customer data and creating customer segment profiles, a customer relationship manager may identify growth targets and develop segment management plans 120-3 for selected customer segments (Step 240). To do so, the customer relationship manger may use customer segmentation system 130 to determine growth targets based on customer data, market analysis, and/or input provided by the staff of the sales organization or by the staff of customer organizations (e.g., through meetings and interviews). A growth target may be a percentage of growth, or a revenue growth amount. For example, as shown in FIG. 3C, customer relationship manager A may identify a machine part sales growth target of 12% (365) for customer segment 2.

When developing segment management plans 120-3 and setting growth targets, customer relationship manager A may consider dealership A's current market share (FIG. 3C, 364) in a customer segment. A customer is often reluctant to overly rely on a sole supplier for products and services because of the inherent business risks related to the reliance on a sole supplier. Customer relationship manager A may set market saturation thresholds in customer segmentation system 130. For example, if dealership A's machine part sales amounted to more than 60% of the whole machine part sales market for a customer segment, customer segmentation system 130 may check the corresponding market saturation threshold and conclude that the specific customer segment is saturated for machine part sales. Customer segmentation system 130 may then notify customer relationship manager A to refrain from further investing marketing/sales effort in the saturated customer segment.

Customer segmentation system 130 may also analyze the projected sales revenue for customer segment 2 (362) and/or other factors to determine a sales growth target (365). In FIG. 3C, customer segmentation system 130 may determine that customer segment 2 is projected to have a $10,000,000 ($129,150,000−$119,150,000) increase in machine part sales, and the market of machine parts is unlikely to be saturated (current market share—41.86%). Based on the projected increase in sales ($10,000,000—8.39%) in the coming twelve months and the fact that the market for the segment is not saturated, customer segmentation system 130 may recommend that customer relationship manager A set a growth target of 12% (365) for the coming twelve months for customer segment 2.

A customer relationship manager may also implement customer management architecture 100 to develop a segment management plan 120-3 for managing action items and initiatives to achieve the identified growth target for the customer segment. A segment management plan 120-3 may include sales/marketing action items and initiatives implemented (or, to be implemented) by a sales organization. Such initiatives may include marketing campaigns, specific promotion offers, dealer manager visits to key customers, etc. A segment management plan 120-3 may also include plans to develop customer relationships, project management activities related to customer management initiatives for the customer segment.

Returning to FIG. 2, after identifying growth targets and developing customer segment management plans 120-3, a customer relationship manager may use customer segmentation system 130 to track customer segment performance (Step 250). A customer relationship manager may implement software programs (e.g., Microsoft excel) in customer management architecture 100 to determine and present sales revenue growth rate and other data related to one or more customer segments in graphical formats. Customer segmentation system 130 may also format the sales revenue growth data and provide the formatted data to web server/application server 110 for display to the customer relationship manager via a user interface. A customer relationship manager may use customer management architecture 100 to monitor graphs to track growth for one or more customer segments regularly, and ensure that the sales organization is on schedule to achieve the growth targets.

FIG. 3D shows a graph tracking the performance of each of the above described customer segments. The performance for each customer segment may be determined by the annualized part sales revenue growth rate for the first and second quarter of a year. For example, as shown in FIG. 3D, customer segment 2 may have a 10% growth rate in the previous year. For the first quarter of this year, customer segment 2 may have a 15% annualized growth rate. For the second quarter of this year, customer segment 2 may have a 10% annualized growth rate. As shown in FIG. 3C, customer relationship manager A has set the annual growth target for part sales at 12% (365) for customer segment 2. Based on the growth rates for the first two quarters of the year, as displayed in FIG. 3D, customer relationship manager A may conclude that customer segment 2 is on schedule to achieve the annual growth target of 12%.

### INDUSTRIAL APPLICABILITY

Methods and systems consistent with the disclosed embodiments may enable a business to implement customer centric business processes to deliver services specific to certain customer segments. By implementing disclosed embodiments, a business manager may divide a market into customer segments according to customers' needs, their past behaviors, and/or their demographic profiles. The business manager may determine the profit potential of each segment by analyzing the revenue and cost impacts of serving each segment. The business manager may further target one or more customer segments according to their profit potential and the sales organization's ability to serve customers using proprietary mechanisms and processes. The business manager may invest resources to tailor product, service, marketing, and distribution programs to match the needs of each target segment. The business manager may further measure performance of each customer segment and adjust the segmentation approach as market conditions change over time.

Methods and systems consistent with the disclosed embodiments may enable a business enterprise to use customer segmentation across business functions and organizational levels for various purposes. For example, a business enterprise may analyze time-based segment characteristics to understand why customers purchase specific products or services, and actively monitor customer purchase behavior over time.

Methods and systems consistent with the disclosed embodiments may further enable business enterprises to obtain customer profile information to enhance enterprises' profitability. For example, by implementing the disclosed embodiments, an enterprise may define effective customer segments that are used to increase sales revenue. The enterprise may prioritize new product development efforts, develop customized marketing programs, choose specific product features by customer segmentation, establish appropriate service options, design an optimal distribution strategy, and determine appropriate product pricing by customer segmentation.

The implementation of the disclosed systems and methods are not limited to the architecture shown in FIG. 1. For example, a customer management architecture may be implemented by a single processor executing program codes to perform one or more of the processes disclose herewith. It will be apparent to those skilled in the art that various modifications and variations of the disclosed embodiments can be made. Additionally, other embodiments of the disclosed methods and systems will be apparent to those skilled in the art from consideration of the specification. It is intended that the specification and examples be considered as exemplary only, with a true scope of the disclosure being indicated by the following claims.

What is claimed:

1. A method for providing customer segmentation, comprising:
defining one or more customer segmentation rules based on one or more business metrics;
organizing customers into one or more customer groups based on the one or more customer segmentation rules;
establishing a customer segment based on the one or more customer groups;
developing a segment management plan for managing customers in the customer segment;
setting a growth target for the customer segment; and
tracking performance of the customer segment in achieving the growth target.

2. The method of claim 1, wherein defining the one or more customer segmentation rules further includes defining a customer segmentation rule based on past sales revenue.

3. The method of claim 1, wherein establishing the customer segment based on the one or more customer groups further includes selecting at least one of the customer groups to form the customer segment.

4. The method of claim 3, wherein developing the segment management plan further includes developing the segment management plan based on a customer segment profile reflecting customer characteristics, and wherein the segment management plan further includes a marketing plan and a project management plan.

5. The method of claim 1, wherein setting the growth target further includes setting the growth target based on a lost sales opportunities factor and a market saturation factor.

6. The method of claim 1, further including:
presenting the performance of the customer segment in a graphic format.

7. The method of claim 5, wherein the lost sales opportunities factor is based on a total sales opportunities amount and an actual sales revenue for the customer segment, and the market saturation factor is based on a ratio of the actual revenue and the total sales opportunities amount.

8. A computer system for managing by customer segmentation, the system including:
a processor; and
a memory storing data including customer data records, wherein the processor is configured to:
receive a customer segmentation rule;
organize customers into one or more customer groups based on the customer segmentation rule;
receive designation of a customer segment based on the one or more customer groups;
receive a segment management plan and a growth target for the customer segment; and
display growth performance of the customer segment in a graphic format for one or more time periods.

9. The system of claim 8, wherein the customer segmentation rule is based on past sales revenue.

10. The system of claim 8, the processor is further configured to:
receive a selection for at least one of the customer groups to form the customer segment.

11. The system of claim 10, wherein the segment management plan is based on a customer segment profile reflecting customer characteristics, and wherein the segment management plan includes a marketing plan and a project management plan.

12. The system of claim 8, wherein the growth target is based on a lost sales opportunities factor and a market saturation factor.

13. The system of claim 8, the processor is further configured to:
provide a report describing the performance of the customer segment over the one or more time period.

14. The system of claim 12, wherein the lost sales opportunities factor is based on a total sales opportunities amount and an actual sales revenue for the customer segment, and the market saturation factor is based on a ratio of the actual revenue and the total sales opportunities amount.

15. A computer-readable medium containing instructions to configure a processor to perform a method for managing customers using customer segmentation, the method comprising:
defining one or more customer segmentation rules based on one or more business metrics;
organizing customers into one or more customer groups based on the one or more customer segmentation rules;
establishing a customer segment based on the one or more customer groups;
developing a segment management plan for managing customers in the customer segment;
setting a growth target for the customer segment; and
tracking performance of the customer segment in achieving the growth target.

16. The method of claim 15, wherein defining the one or more customer segmentation rules further includes defining a customer segmentation rule based on past sales revenue.

17. The method of claim 15, wherein establishing the customer segment based on the one or more customer groups further includes selecting at least one of the customer groups to form the customer segment.

18. The method of claim 17, wherein developing the segment management plan further includes developing the segment management plan based on a customer segment profile reflecting customer characteristics, and wherein the segment management plan further includes a marketing plan and a project management plan.

19. The method of claim 15, wherein setting the growth target further includes setting the growth target based on a lost sales opportunities factor and a market saturation factor.

20. The method of claim 15, further including:
displaying the performance of the customer segment in a graphic format.
